(19) United States
(12) Patent Application Publication
(10) Pub. No.: US 2023/0202247 A1
(43) Pub. Date: Jun. 29, 2023

(54) USING A LOOP ANTENNA ELEMENT FOR WIRELESS SIGNAL TRANSMISSION

(71) Applicant: SENSATA TECHNOLOGIES, INC., ATTLEBORO, MA (US)

(72) Inventors: NICOLAS R. HENRIET, ARCON (FR); NICOLAS GARNIER, SAONE (FR); PHILIP M. DORMAN, CARRICKFERGUS (GB); MARK P. REILLY, LISBURN (GB); ROBERT M.A. MCLORIE, BALLYCLARE (IE)

(21) Appl. No.: 17/916,021

(22) PCT Filed: Mar. 30, 2021
(86) PCT No.: PCT/US2021/024832

§ 371 Date: Sep. 29, 2022

Related U.S. Application Data
(60) Provisional application No. 63/002,881, filed on Mar. 31, 2020.

(51) Int. Cl. B60C 23/04; H01Q 1/22

(52) U.S. Cl. CPC B60C 23/0452; H01Q 1/2241

(57) ABSTRACT

Apparatuses, systems, wireless signal transmission devices, tire pressure monitoring system (TPMS) sensors, and methods of using a loop antenna element for wireless signal transmission are disclosed. In a particular embodiment, a TPMS sensor is disclosed that includes one or more sub-sensors configured to sense data associated with a tire. In this embodiment, the TPMS sensor also includes a printed circuit board (PCB) coupled to the one or more sub-sensors. The PCB has a top surface, a bottom surface substantially parallel to the top surface, and an edge surface between the top surface and the bottom surface. According to this embodiment, the TPMS sensor also includes a loop antenna element on the edge surface of the PCB.

### BACKGROUND

In the automotive industry, tire pressure monitoring systems (TPMS) sensors may be mounted to a tire or wheel and configured to monitor tire parameters, such as tire air pressure and temperature. TPMS sensors typically include a radio frequency (RF) transmitter and an antenna element for transmitting the monitored tire parameters to a receiving system in a vehicle. The efficiency of the antenna element in transmitting the tire parameters is dependent on the design and configuration of the antenna element.

### SUMMARY OF INVENTION

Apparatuses, systems, wireless signal transmission devices, tire pressure monitoring system (TPMS) sensors, and methods for using a loop antenna element for wireless signal transmission are disclosed. In a particular embodiment, a TPMS sensor is disclosed that includes one or more sub-sensors configured to sense data associated with a tire. In this embodiment, the TPMS sensor also includes a printed circuit board (PCB) coupled to the one or more sub-sensors. The PCB has a top surface, a bottom surface substantially parallel to the top surface, and an edge surface between the top surface and the bottom surface. According to this embodiment, the TPMS sensor also includes a loop antenna element on the edge surface of the PCB.

In another embodiment, a method for using a loop antenna element for wireless signal transmission in a tire pressure monitoring system (TPMS) sensor is disclosed. In this example method, the TPMS sensor includes one or more sub-sensors and a printed circuit board (PCB) having a top surface, a bottom surface, and an edge surface between the top surface and the bottom surface. In this particular embodiment, the method includes the TPMS sensor generating one or more tire parameters using sensed data from the one or more sub-sensors of the TPMS sensor. The method also includes the TPMS sensor transmitting as a wireless signal, the one or more tire parameters using a loop antenna element on the edge surface of the PCB.

In another embodiment, a wireless signal transmission device is disclosed that includes a printed circuit board (PCB) having a top surface, a bottom surface substantially parallel to the top surface, and an edge surface between the top surface and the bottom surface. In this embodiment, the wireless signal transmission device includes a loop antenna element on the edge surface of the PCB. In addition, the wireless signal transmission device also includes a communication circuit coupled to the loop antenna element.

As will be explained below, the efficiency of a loop antenna element is directly linked to the size of the internal area of the loop antenna. Specifically, increasing the size of the internal area of the loop antenna, increases the radiating resistance of the loop antenna, and thus increases the efficiency of the loop antenna. One of the benefits of mounting a loop antenna element to the edge surface of the PCB of a TPMS sensor, or any type of wireless signal transmission device according to embodiments of the present disclosure is that the internal area of the loop antenna is maximized, resulting in increased radiating resistance and thus increased performance of the loop antenna element.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF DRAWINGS

FIG. 1A sets forth a diagram illustrating an isometric view of an exemplary wireless signal transmission device that uses a loop antenna element for wireless signal transmission in accordance with at least one embodiment of the present invention;

FIG. 1B sets forth a diagram illustrating a side view of the wireless signal transmission device of FIG. 1A;

FIG. 2 sets forth a block diagram illustrating an exemplary wireless signal transmission device that uses a loop antenna element for wireless signal transmission in accordance with at least one embodiment of the present invention;

FIG. 3 is a flowchart to illustrate an implementation of a method for using a loop antenna element for wireless signal transmission in a tire pressure monitoring system (TPMS) sensor in accordance with at least one embodiment of the present invention;

FIG. 4 is a flowchart to illustrate another implementation of a method for using a loop antenna element for wireless signal transmission in a tire pressure monitoring system (TPMS) sensor in accordance with at least one embodiment of the present invention; and

FIG. 5 sets forth a diagram illustrating an exemplary tire pressure monitoring system (TPMS) sensor that uses a loop antenna element for wireless signal transmission in accordance with at least one embodiment of the present invention.

### DESCRIPTION OF EMBODIMENTS

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements,

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

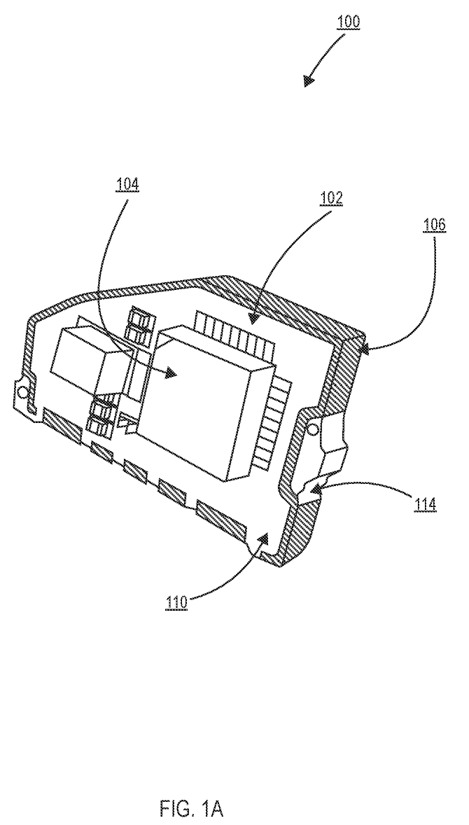

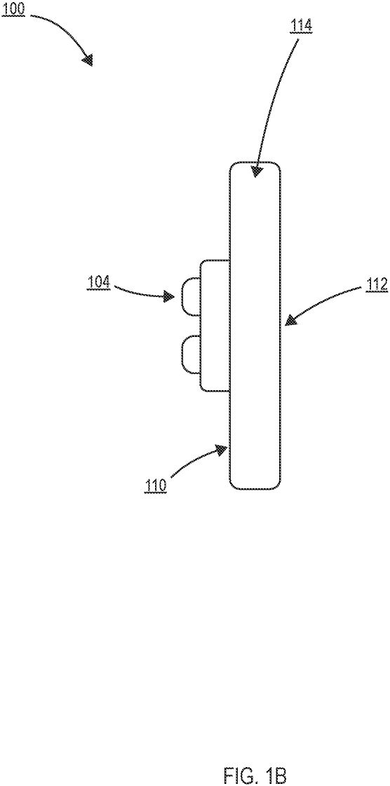

Exemplary apparatuses, systems, wireless signal transmission devices, tire pressure monitoring system (TPMS) sensors, and methods for using a loop antenna element for wireless signal transmission are described with reference to the accompanying drawings, beginning with FIG. 1A. FIG. 1A sets forth a diagram illustrating an isometric view of an exemplary wireless signal transmission device (100) that uses a loop antenna element for wireless signal transmission in accordance with at least one embodiment of the present invention. For further explanation, FIG. 1B sets forth a diagram illustrating a side view of the wireless signal transmission device (100) of FIG. 1A.

The wireless signal transmission device (100) of FIGS. 1A and 1B includes a printed circuit board (PCB) (102) having a top surface (110), a bottom surface (112) that is substantially parallel to the top surface (110), and edge surface (114) between the top surface (110) and the bottom surface (112). The edge surface (114) surrounds an interior portion of the PCB (102) between the top surface (110) and the bottom surface (112). In the example of FIG. 1, a plurality of electrical components (104) is coupled to the top surface (110) of the PCB (102). Examples of electrical components that may be included in the plurality of electrical components (104) according to the present disclosure include but are not limited to: a pressure sensor, a motion input, a low frequency (LF) input, a radio frequency (RF) circuit, a battery, a processor, and a memory. In a particular embodiment, the wireless signal transmission device (100) functions as a tire pressure monitoring system (TPMS) sensor for monitoring and processing tire parameters associated with a vehicle tire. In this example embodiment, one or more of the electrical components may function as sub-sensors that are configured to sense data associated with a tire.

The wireless signal transmission device (100) also includes a loop antenna element (106) that is on the edge surface (114) of the PCB (102). Because the loop antenna element is on the edge surface, the loop antenna element (106) may be referred to as an edge mounted loop antenna element. The edge surface may be considered to have a length and a width, where the width of the edge surface is generally the perpendicular distance between the two substantially parallel planes of the top surface and the bottom surface of the PCB. Likewise, the loop antenna element may be considered to have a track length and a track width, where the track width is generally measured in the same direction as the width of the edge surface. The track length of the loop antenna element substantially follows the length of the edge surface of the PCB, such that the track of the loop antenna element forms a loop around the edge surface of the PCB. A loop area of the loop antenna element (106) is the area between one edge of the track width of the loop antenna element. Because the loop antenna element is on the edge surface of the PCB, the area between one edge of the track width is generally the area of the shape of the top surface or bottom surface of the PCB. As will be explained below, the efficiency of a loop antenna element is directly linked to a radiating resistance of the loop antenna element, which is directly dependent on the size of the loop area of the loop antenna element.

In a particular embodiment, the radiating resistance of the loop antenna element (106) may be calculated by the following formula:

$${R}_{r a d} = 320 {π}^{4} \left({A}^{2} / {λ}^{4}\right)$$

In the above formula, R_{rad} is the radiating resistance; A is the loop area of the loop antenna element (106); and λ is the wavelength of the loop antenna element (106).

According to the above formula, increasing the size of the internal area of the loop antenna element (106), increases the radiating resistance of the loop antenna element (106), and thus increases the efficiency of the loop antenna element (106). Therefore, the loop area has a positive impact on the performance of the loop antenna element (106).

One of the benefits of the loop antenna element (106) being on the edge surface (114) of the PCB (102) of a wireless signal transmission device (100) instead of a loop antenna element being on the top surface (110) or the bottom surface (112) of the PCB (102) is that the internal loop area of the loop antenna element (106) is maximized, resulting in increased radiating resistance and thus increased performance of the loop antenna element (106). For example, if the loop antenna element is placed in a loop on the top surface, the internal loop area of that loop antenna element would be within the interior of the top surface and because the track would have a certain track thickness, the loop would have a loop area that is smaller than the loop area of a loop antenna element on the edge surface that is between the top surface and the bottom surface of the PCB. Furthermore, there may be certain clearance requirements that require a loop antenna element placed on the top surface or bottom surface to be a particular distance from the edge of the top surface or the bottom surface. These clearance requirements may further reduce the interior loop area of a loop antenna element placed on the top surface or bottom surface of a PCB relative to a loop area of a loop antenna element on the edge surface of the same PCB.

Furthermore, in contrast to a loop antenna element on the top surface or the bottom surface, an edge mounted loop antenna element, as described according to embodiments of the present invention, has increased loop antenna element performance that is achieved without increasing the size and weight of the wireless signal transmission device. In an embodiment in which the wireless signal transmission device (100) is used as a tire pressure monitoring system (TPMS) sensor, increasing the size and the weight of the TPMS sensor may reduce rubber valve life during tire motion and increase the likelihood of the TPMS sensor being struck by the tire during the tire fitting process. Both of these negative consequences can be avoided by increasing the loop antenna element area without increasing the PCB size by placing the loop antenna element on the edge surface of the PCB in accordance with the present disclosure.

A loop antenna element that is on the edge surface of the PCB may include a loop antenna element that is printed on the edge surface or alternatively, a loop antenna element that is a separate piece that is attached or coupled to the PCB. In addition, a loop antenna element that is on the edge surface of the PCB may include a loop antenna element (106) that is coupled to one or more electrical components (e.g., a communication circuit, such as an RF circuit) of the plurality of electrical components (104).

In a particular embodiment, the wireless signal transmission device (100), functioning as a TPMS sensor, includes a pressure sensor that measures pressure and temperature values for a tire coupled to the wireless signal transmission device (100). In this example, the pressure/temperature values may be read by or transmitted to a processor of the wireless signal transmission device (100). The processor may process the measured pressure and temperature values and transmit the processed values (e.g., tire parameters) to a communication circuit (e.g., an RF circuit) for transmission, as a wireless signal, via the loop antenna element (106) to another component (e.g., a wireless signal receiver device; an electronic control unit (ECU)) of the vehicle, a TPMS receiver). In this example, the TPMS receiver is configured to receive wireless signals from one or more TPMS sensors.

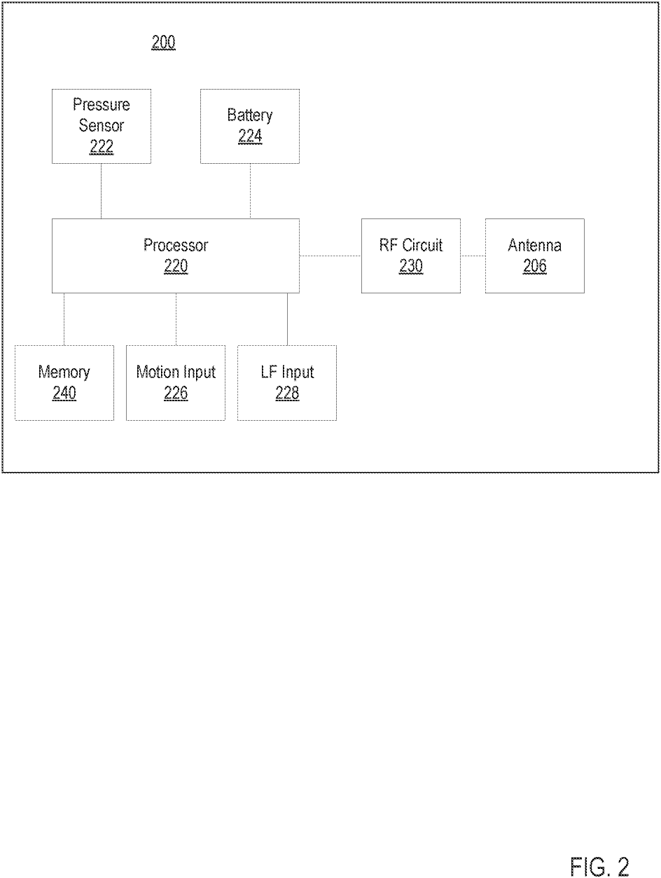

For further explanation, FIG. 2 sets forth block diagram illustrating an exemplary wireless signal transmission device (200) that uses a loop antenna element (206) for wireless signal transmission in accordance with at least one embodiment of the present invention. In a particular embodiment, the wireless signal transmission device (200) is configured as a tire pressure monitoring system (TPMS) sensor.

In the example of FIG. 2, the wireless signal transmission device (200) includes a plurality of electrical components comprising a processor (220), a pressure sensor (222), a battery (224), a memory (240), a motion input (226), a low frequency (LF) input (228), an RF circuit (230), and the loop antenna element (206).

The processor (220) may include or implement a microcontroller, an Application Specific Integrated Circuit (ASIC), a digital signal processor (DSP), a programmable logic array (PLA) such as field programmable gate array (FPGA), or other data computation unit in accordance with the present disclosure. In the example embodiment in which the wireless signal transmission device (200) acts as a TPMS sensor, the memory (240) may store computer program instructions that when executed by the processor (220) cause the processor to carry out operations for measuring, monitoring, and sensing data from sub-sensors (e.g., a pressure sensor), generating one or more tire parameters using the sensed data from the sub-sensors, and transmitting the tire parameters. The memory may also be used to store the one or more tire parameters.

In a particular embodiment, the pressure sensor (222) of the wireless signal transmission device (200) may measure pressure and temperature values for a tire coupled to the wireless signal transmission device (200). In this example, the pressure/temperature values may be read by or transmitted to the processor (220) of the wireless signal transmission device (200). The processor (220) may process the measured pressure and temperature values and transmit the processed values to the RF circuit (230) for transmission, as a wireless signal, via the loop antenna element (206) to another component (e.g., a TPMS receiver; an electronic control unit (ECU) of a vehicle).

As explained above in the description of FIGS. 1A and 1B, in a wireless signal transmission device according to embodiments of the present disclosure, the loop antenna element (206) is on the edge surface of the PCB of the wireless signal transmission device. A loop antenna element that is on the edge surface of the PCB of wireless signal transmission device has an internal loop area that is greater than a loop antenna element that is on the top surface or the bottom surface of the same size PCB. A larger internal loop area results in a larger radiating resistance and thus greater performance of the loop antenna element. Furthermore, this increase in antenna performance is achieved without increasing the size and weight of the sensor. As explained above, in the example where the wireless signal transmission device functions as a tire pressure monitoring system (TPMS) sensor, increasing the size and the weight of the wireless signal transmission device may reduce rubber valve life during tire motion and increase the likelihood of the TPMS sensor being struck by the tire during the tire fitting process. In accordance with the present disclosure, both of these negative consequences can be avoided by mounting the loop antenna element to the edge surface of the PCB instead of mounting to the top surface or bottom surface of the PCB. Readers of skill in the art will also realize that an edge mounted loop antenna element may be used in other types of TPMS sensors with a valve that is not rubber material and in TPMS sensors with no valves.

As is readily apparent from the foregoing description, the present disclosure generally provides an improved loop antenna element for a wireless signal transmission device (e.g., the wireless signal transmission device (100) of FIG. 1A, the wireless signal transmission device (200) of FIG. 2). In particular, the loop antenna element of the wireless signal transmission device of the present disclosure, which is on the edge surface of the PCB, generally has greater radiating resistance than another wireless signal transmission device that has the same size PCB with a loop antenna element on a top surface or bottom surface of the PCB.

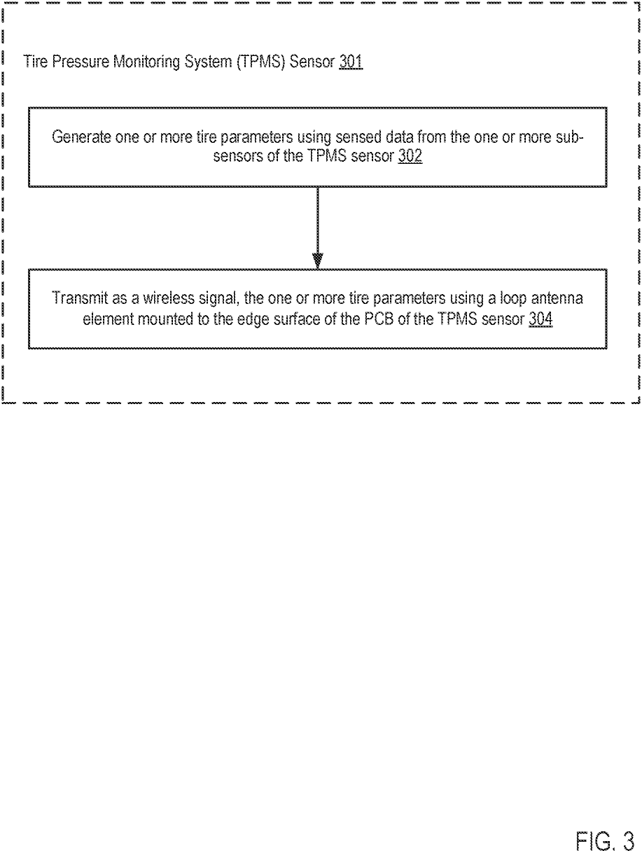

For further explanation, FIG. 3 sets forth a flowchart to illustrate an implementation of a method for using a loop antenna element for wireless signal transmission in a tire pressure monitoring system (TPMS) sensor in accordance with at least one embodiment of the present invention. Examples of tire parameters include but are not limited to: tire pressure, tire air temperature, acceleration data, rotation data, and other types of data that can be measured and generated by a sensor in close proximity to a tire. The method of FIG. 3 includes a TPMS sensor (301) generating (302) one or more tire parameters using sensed data from the one or more sub-sensors of the TPMS sensor. Generating (302) one or more tire parameters using sensed data from the one or more sub-sensors of the TPMS sensor may be carried out by receiving sensed data from one or more sub-sensors; storing the sensed data in memory of the TPMS sensor; converting, processing, or otherwise using the sensed data to create tire parameters.

The method of FIG. 3 also includes transmitting (304) as a wireless signal, by the TPMS sensor (301), the one or more tire parameters using a loop antenna element on the edge surface of the PCB. Transmitting (304) as a wireless signal, by the TPMS sensor (301), the one or more tire parameters using a loop antenna element on the edge surface of the PCB may be carried out by using a communication protocol to a transmit a wireless signal.

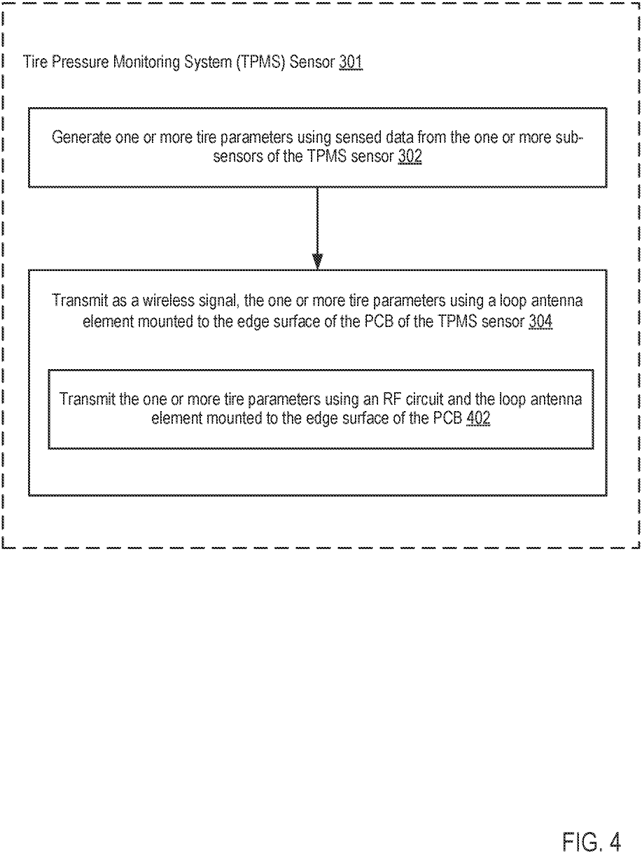

For further explanation, FIG. 4 sets forth a flowchart to illustrate another implementation of a method for using a loop antenna element for wireless signal transmission in a tire pressure monitoring system (TPMS) sensor in accordance with at least one embodiment of the present invention. The method of FIG. 4 is similar to the method of FIG. 3 in that the method of FIG. 4 also includes generating, by the TPMS sensor, one or more tire parameters using sensed data from the one or more sub-sensors of the TPMS sensor; and transmitting as a wireless signal, by the TPMS sensor, the one or more tire parameters using a loop antenna element on the edge surface of the PCB.

In the example of FIG. 4, however, transmitting as a wireless signal, by the TPMS sensor, the one or more tire parameters using a loop antenna element on the edge surface of the PCB includes transmitting (402), by the TPMS sensor (301), the one or more tire parameters using the RF circuit and the loop antenna element on the edge surface of the PCB. Transmitting (402), by the TPMS sensor (301), the one or more tire parameters using the RF circuit and the loop antenna element on the edge surface of the PCB may be carried out by transmitting a signal Over The Air (OTA) using RF in the ultra high frequency (UHF) band.

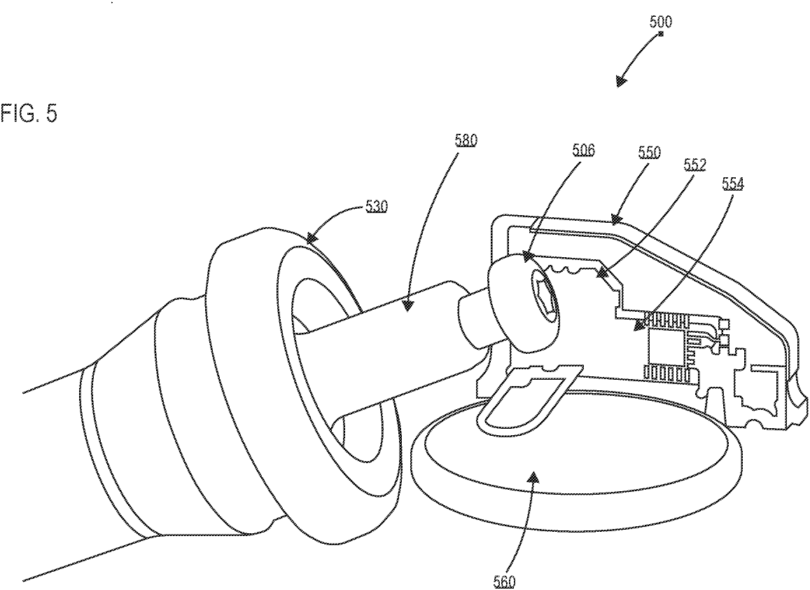

For further explanation, FIG. 5 sets forth a diagram illustrating an exemplary tire pressure monitoring system (TPMS) sensor (600) that uses a loop antenna element (650) for wireless signal transmission in accordance with at least one embodiment of the present invention. The TPMS sensor (600) includes a printed circuit board (PCB) (652), a battery (660), and a valve stem (680) with a valve screw (606). Coupled to the PCB (652) is a plurality of electrical components (654) including sub-sensors for sensing data associated with a tire. In the example of FIG. 5, the loop antenna element (650) is an edge mounted loop antenna element mounted on an edge surface between a top surface and a bottom surface of the PCB.

Exemplary embodiments of the present invention are described largely in the context of a fully functional computer system for using a loop antenna element for wireless signal transmission. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be an apparatus, device, system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s) In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A tire pressure monitoring system (TPMS) sensor comprising: one or more sub-sensors configured to sense data associated with a tire; a printed circuit board (PCB) coupled to the one or more sub-sensors, the PCB having a top surface, a bottom surface substantially parallel to the top surface, and an edge surface between the top surface and the bottom surface; and a loop antenna element on the edge surface of the PCB.

2. The TPMS sensor of statement 1 further comprising: a communication circuit coupled to the loop antenna element.

3. The TPMS sensor of statements 1 or 2 further comprising a processor configured to: generate, based on the sensed data from the one or more sub-sensors, one or more tire parameters; and transmit, via the communication circuit and the loop antenna element, the one or more tire parameters.

4. The TPMS sensor of any of statements 1-3, wherein the edge surface surrounds an interior portion of the PCB between the top surface and the bottom surface.

5. The TPMS sensor of any of statements 1-4 further comprising one or more electrical components attached to the top surface of the PCB.

6. The TPMS sensor of any of statements 1-5 wherein the PCB uses the loop antenna element to transmit to a TPMS receiver, one or more tire parameters.

7. The TPMS sensor of any of statements 1-6 wherein the communication circuit includes a radio frequency (RF) circuit.

8. A method for wireless signal transmission with a tire pressure monitoring system (TPMS) sensor, the TPMS sensor including one or more sub-sensors and a printed circuit board (PCB), the PCB having a top surface, a bottom surface, and an edge surface between the top surface and the bottom surface, the method comprising: generating, by the TPMS sensor, one or more tire parameters using sensed data from the one or more sub-sensors of the TPMS sensor; and transmitting as a wireless signal, by the TPMS sensor, the one or more tire parameters using a loop antenna element on the edge surface of the PCB.

9. The method of statement 8 wherein the TPMS sensor includes a communication circuit coupled to the loop antenna element.

10. The method of statements 8 or 9 wherein transmitting, by the TPMS sensor, the one or more tire parameters using a loop antenna element on the edge surface of the PCB includes transmitting, by the TPMS sensor, the one or more tire parameters using the RF circuit and the loop antenna element on the edge surface of the PCB.

11. The method of any of statements 8-10 wherein the edge surface surrounds an interior portion of the PCB between the top surface and the bottom surface.

12. The method of any of statements 8-11 wherein the PCB includes electrical components attached to the top surface of the PCB.

13. The method of any of statements 8-12 wherein the PCB uses the loop antenna element to transmit the one or more tire parameters to a TPMS receiver.

14. The method of any of statements 8-13 wherein the communication circuit includes a radio frequency (RF) circuit.

15. A wireless signal transmission device comprising: a printed circuit board (PCB) having a top surface, a bottom surface substantially parallel to the top surface, and an edge surface between the top surface and the bottom surface; a loop antenna element on the edge surface of the PCB; and a communication circuit coupled to the loop antenna element.

16. The wireless signal transmission device of statement 15 further comprising a processor configured to transmit, via the communication circuit and the loop antenna element, a wireless signal.

17. The wireless signal transmission device of statements 15 or 16 wherein the edge surface surrounds an interior portion of the PCB between the top surface and the bottom surface.

18. The wireless signal transmission device of any of statements 15-17 further comprising one or more electrical components attached to the top surface of the PCB.

19. The wireless signal transmission device of any of statements 15-18 wherein the wireless signal transmission device is a tire pressure monitoring system (TPMS) sensor.

20. The wireless signal transmission device of any of statements 15-18 wherein the PCB uses the loop antenna element to transmit one or more tire parameters to a TPMS receiver.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A tire pressure monitoring system (TPMS) sensor comprising:
one or more sub-sensors configured to sense data associated with a tire;
a printed circuit board (PCB) coupled to the one or more sub-sensors, the PCB having a top surface, a bottom surface substantially parallel to the top surface, and an edge surface between the top surface and the bottom surface; and
a loop antenna element on the edge surface of the PCB.

2. The TPMS sensor of claim 1 further comprising:
a communication circuit coupled to the loop antenna element.

3. The TPMS sensor of claim 2 further comprising a processor configured to:
generate, based on the sensed data from the one or more sub-sensors, one or more tire parameters; and
transmit, via the communication circuit and the loop antenna element, the one or more tire parameters.

4. The TPMS sensor of claim 1 wherein the edge surface surrounds an interior portion of the PCB between the top surface and the bottom surface.

5. The TPMS sensor of claim 1 further comprising one or more electrical components attached to the top surface of the PCB.

6. The TPMS sensor of claim 1 wherein the PCB uses the loop antenna element to transmit to a TPMS receiver, one or more tire parameters.

7. The TPMS sensor of claim 1 wherein the communication circuit includes a radio frequency (RF) circuit.

8. A method for wireless signal transmission with a tire pressure monitoring system (TPMS) sensor, the TPMS sensor including one or more sub-sensors and a printed circuit board (PCB), the PCB having a top surface, a bottom surface, and an edge surface between the top surface and the bottom surface, the method comprising:
generating, by the TPMS sensor, one or more tire parameters using sensed data from the one or more sub-sensors of the TPMS sensor, and
transmitting as a wireless signal, by the TPMS sensor, the one or more tire parameters using a loop antenna element on the edge surface of the PCB.

9. The method of claim 8 wherein the TPMS sensor includes a communication circuit coupled to the loop antenna element.

10. The method of claim 9 wherein transmitting, by the TPMS sensor, the one or more tire parameters using a loop antenna element on the edge surface of the PCB includes transmitting, by the TPMS sensor, the one or more tire parameters using the communication circuit and the loop antenna element on the edge surface of the PCB.

11. The method of claim 8 wherein the edge surface surrounds an interior portion of the PCB between the top surface and the bottom surface.

12. The method of claim 8 wherein the PCB includes electrical components attached to the top surface of the PCB.

13. The method of claim 8 wherein the PCB uses the loop antenna element to transmit the one or more tire parameters to a TPMS receiver.

14. The method of claim 8 wherein the communication circuit includes a radio frequency (RF) circuit.

15. A wireless signal transmission device comprising:
a printed circuit board (PCB) having a top surface, a bottom surface substantially parallel to the top surface, and an edge surface between the top surface and the bottom surface;
a loop antenna element on the edge surface of the PCB; and
a communication circuit coupled to the loop antenna element.

16. The wireless signal transmission device of claim 15 further comprising a processor configured to transmit, via the communication circuit and the loop antenna element, a wireless signal.

17. The wireless signal transmission device of claim 15 wherein the edge surface surrounds an interior portion of the PCB between the top surface and the bottom surface.

18. The wireless signal transmission device of claim 15 further comprising one or more electrical components attached to the top surface of the PCB.

19. The wireless signal transmission device of claim 15 wherein the wireless signal transmission device is a tire pressure monitoring system (TPMS) sensor.

20. The wireless signal transmission device of claim 19 wherein the PCB uses the loop antenna element to transmit one or more tire parameters to a TPMS receiver.
